(19) United States
(12) Patent Application Publication
(10) Pub. No.: US 2003/0086684 A1
(43) Pub. Date: May 8, 2003

(54) Video greeting apparatus

(76) Inventors: Steven Robert Smith, Warwickshire (GB); John Darren Stephens, Hull (GB); Darren Paul Bilton, Hull (GB); David Barr Rankin, Warwickshire (GB)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/271,685

(22) Filed: Oct. 16, 2002

(30) Foreign Application Priority Data
Oct. 17, 2001 (GB) GB 0124920.0
Feb. 21, 2002 (GB) GB 0204032.7

(51) Int. Cl. H04N 5/76; H04N 5/225

(52) U.S. Cl. 386/46; 386/117

(57) ABSTRACT

An apparatus and method for producing a video message, particularly a greeting or post card, comprising a camera for viewing a user, video recording means for presenting to a user on a video recording medium, such as a CD or DVD, a recorded message and means for vending the recording in or with an envelope or the like.

### FIELD OF INVENTION

This invention relates to a method and apparatus for producing video communications for dispatch to a third party, and in particular to recording an audio-visual communication recorded on a Compact Disc (CD) or the like, particularly where the communication takes the form of a greeting card or post card.

### BACKGROUND OF THE INVENTION

Video messages recorded by a PC on to, for example, a hard disc, for subsequent dispatch by e-mail to a third party are well known. However, this requires a sender to have access to a PC with a video camera or the like and also an internet connection. Such video communications would normally be sent as attachments to an e-mail. A recipient of such a file may be anxious about opening it in case it contains a virus. Further, many people lack basic knowledge on how to record and send such communications or simply do not have access to the necessary equipment.

Traditional greeting cards are also known, and indeed are commonplace. Such cards are often purchased in haste. Thus, senders frequently have difficulty in finding a suitable card, either through lack of time or as a result of limited selections in retail outlets. In such circumstances, the sender is likely to be attracted by the possibility of sending a more personal greeting in the form of an audio and visual message. At present there is no equipment available to the public that allows an individual or group of people to simply and quickly dispatch a video greeting other than by e-mail.

### BRIEF SUMMARY OF THE INVENTION

An aim of the present invention is to provide a video messaging apparatus that overcomes at least some of the above problems. A further aim is to provide messaging apparatus that allows a selected form of video greeting or the like to be produced in a booth or the like in a format suitable for sending by post etc., to the intended recipient.

In a first aspect the invention comprises apparatus for producing a video communication comprising: a video camera for viewing a user; a display: a processor with memory and software for presenting instructions on the display to a user; video recording means; means for presenting a selected unrecorded video recording medium to the video recording means; means for presenting to the user on the video recording medium a recording of the communication; and means for vending the recording to the user with a presentation package. The means for presenting a video recording medium to a video recording means may comprise an arm with a suction pad, said arm mounted on a track and moveable along said track by motor means. The arm may ascend or descend as it traverses the track and the arm may during its travel pass from a position below to a position above the chute plate. The chute plate may be pivotably mounted and may move from a first position where the plate lies in a generally vertical plane to a second position where the plate forms part of a chute for transfer of a released recording medium into a vending aperture. A partial vacuum may be applied to the suction pad by suction means such as a solenoid pump.

In a second aspect the invention comprises apparatus for producing a video communication comprising: a video camera for viewing a user; video recording means for presenting to the user on a video recording medium a recording of the communication; and means for vending the recording to the user in or with a presentation package.

In a third aspect the invention comprises apparatus for producing a video communication comprising: a video camera for viewing a user; a display; a processor with memory and software for presenting instructions on the display to the user; video recording means that accepts data storage means presented by a user, means of validating that prepayment has been received and means of dispensing to the user a recording of the video communication, on the data storage means

In a fourth aspect the invention comprises a method of producing a video greeting on a video recording medium comprising the steps of a user selecting the preferred type of greeting; recording a video greeting on a video recording medium; and vending the recording to the user in or with a presentation package.

In a fifth aspect the invention comprises a method of producing a video communication comprising the steps of: a user presenting data storage means to a video recorder; recording a video greeting; validating that prepayment has been received and dispensing to the user a recording of the video communication, on the data storage means.

In a sixth aspect the invention comprises a method of producing a video communication comprising the steps of: a user presenting data storage means to a video recorder; recording a video greeting; authenticating storage means as authorised for use in said apparatus and dispensing to the user a recording of the video communication, on the data storage means.

### BRIEF DESCRIPTION OF THE DRAWINGS

The invention will now be described, by way of example only, by reference to the following schematic figures in which;

FIG. 1 shows the major components of the invention,

FIG. 2 is a perspective view of the apparatus according to a first embodiment of the invention,

FIG. 3 is a further perspective view of the apparatus of FIG. 2, with the servicing access door opened,

FIGS. 4 to 7 are perspective views showing at four different stages of their operation the main components of the disc dispensing mechanism used in the apparatus of FIG. 2,

FIG. 8 is a plan view of a part of another disc dispensing mechanism,

FIG. 9 is a side elevation corresponding to FIG. 5,

FIGS. 10-a to 10-i show views presented to a user on a display during recording of a message,

FIG. 11 shows two views of the video as seen during playback,

FIG. 12 shows the front face of various greetings discs produced by the apparatus of the invention,

FIG. 13 shows in opened form a presentation package for the greetings discs shown in FIG. 6, and

FIG. 14 shows major components of the apparatus according to a second embodiment of the invention.

### DETAILED DESCRIPTION OF THE INVENTION

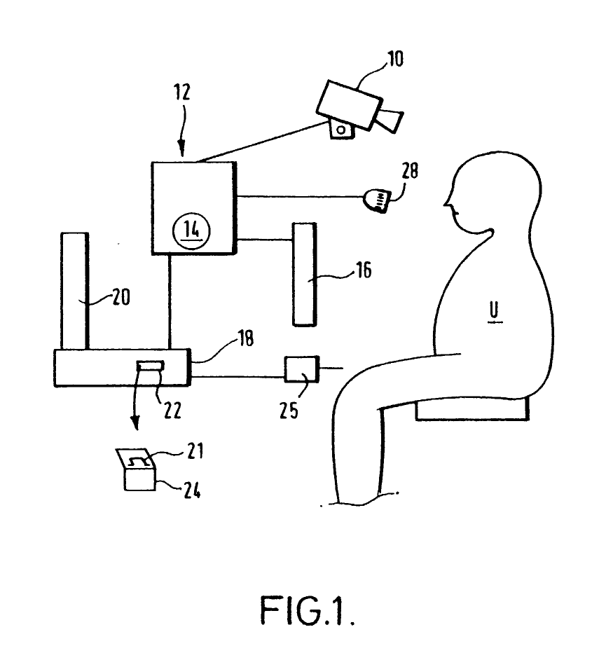

FIG. 1 shows, in diagramatic form only, the main components of the apparatus according to the invention. A video camera 10 records moving images of a user (U) and these are sent to a processor 12, for example within a PC, with memory 14 associated with said processor 12. Memory 14 will normally comprise both permanent “memory”, for example a hard disc and transient memory, for example RAM. The processor 12 is linked to a display unit 16 with a touch screen facility and to a video recorder 18 that can write to a compact disc (CD). Thus, a user may respond to instructions presented on the display using the touch screen. A compact disc dispenser 20 may be provided to enable a disc with a preselected label to be selected and recorded upon. The recorded disc 21 is optionally enclosed in packaging (envelope) 24 and dispensed via a vending aperture 22. Payment means 25, for example a credit card reader or equivalent is provided for a user to make payment for using the apparatus. The apparatus may also include a microphone 28 connected to processor 12 to allow both a visual and audio message to be recorded.

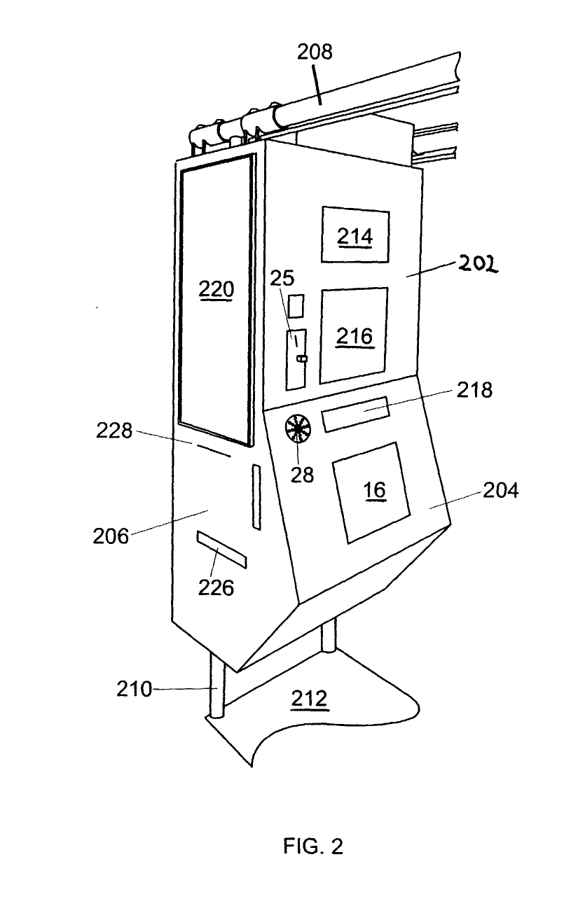

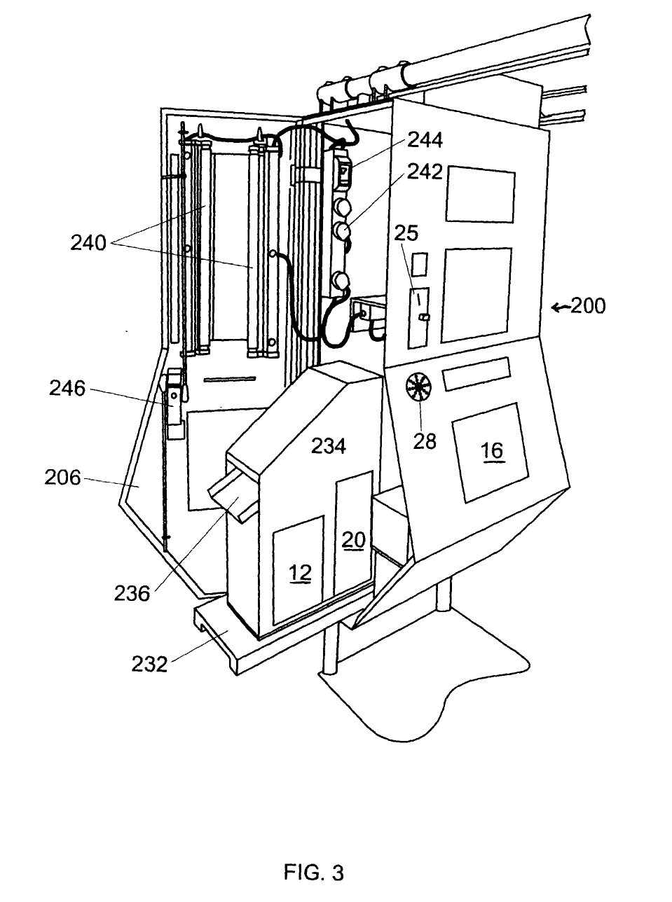

FIGS. 2 and 3 show perspective views of a preferred embodiment of the apparatus. The apparatus is contained within an outer case 200 comprising a front vertical panel 202, a pair of inclined panels 204, and side panels 206. Curtain rail(s) 208 may be attached to the top face of case 200 and the bottom face of case 200 is preferably attached to a base plate 212 (only part shown) by support members 210. Thus, case 200 is supported in a stable manner by base plate 212, that rests on an interior or exterior floor. Of course, plate 212 may be fixed to the floor for security reasons. Vertical front panel 202 and inclined panel 204 have illumination means 214 and 218 respectively. These comprise light transparent windows 214 and 218 behind which are lamps. Also located in front panel 202 is an optically transparent screen 216 (behind which is located video camera 10), and payment means 25. The payment means may comprise a card reader to enable credit cards and the like to be used and/or means of accepting cash payment. Inclined panel 204 has a display unit 16 and microphone 28 and/or a loudspeaker. Case 200 has side panels one of which 206 in mounted on hinges so that it may be opened. The upper portion of side panel 206 has an illuminated panel 220 which may be used to advertise the services available using the apparatus. Below panel 220 there are horizontal dispensing slots 226, 228. Slot 226 is used to dispense a recorded CD (see latter). Slot 228 is used to dispense envelopes one at a time. A standard envelope stacking and dispensing mechanism (not shown) is located on the inside of panel 206 such that when a disc is dispensed through slot 226 (see latter) an envelope is simultaneously dispensed through slot 228.

FIG. 3 is a perspective view of the apparatus of FIG. 2 with side panel 206 in the open position; as required for servicing. The case 200 houses a sub-enclosure 234 slidably fixed to the case 200 by a sliding tray 232; such that when side panel 206 is open the sub-enclosure 234 may be slid sideways through the opening created thereby. Sub-enclosure 234 houses processor 12, video recorder 18 and also disc dispenser 20. Strip lights 240 provide the illumination means for the illuminated panel 220. Power socket board 242 provides several standard plug sockets that are protected by a fuse and or circuit breaker 244. Lock mechanism 246 is provided to allow side panel 206 to be securely locked shut when the apparatus is in normal use.

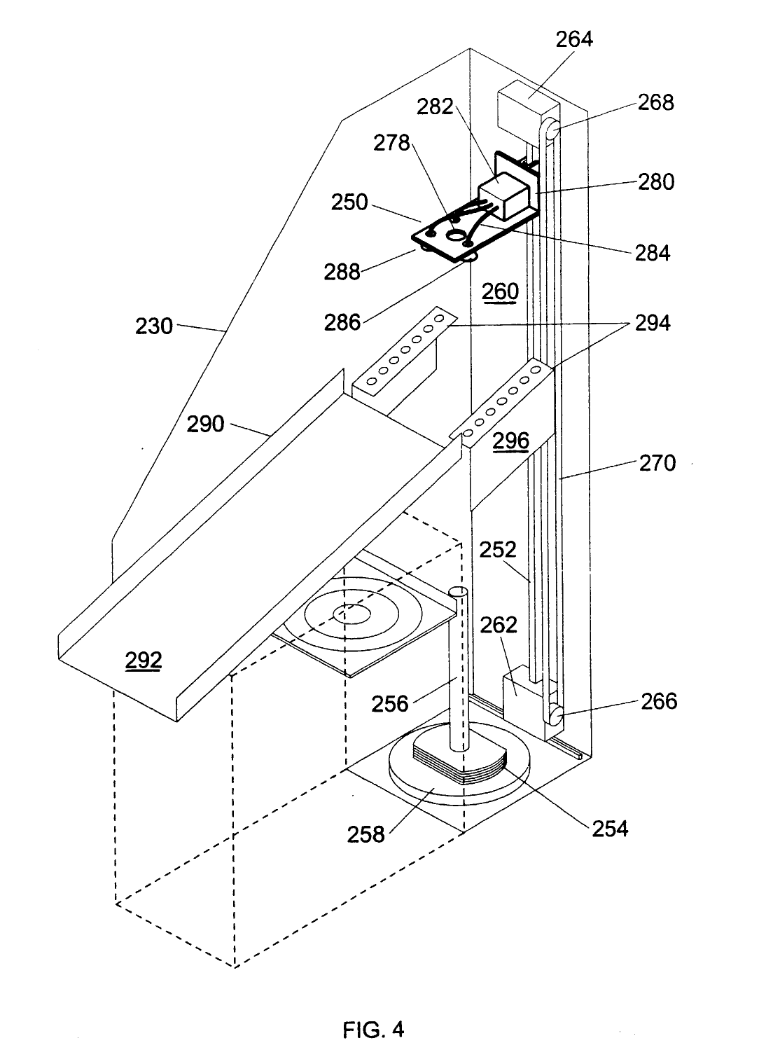

The apparatus provides means 20 of presenting a selected unrecorded disc to the video recorder 18. The disc dispenser 20 and its position in relation to units 12,14 and 18 is schematically illustrated in FIGS. 4 to 7; which show four different stages in the disc dispensing cycle.

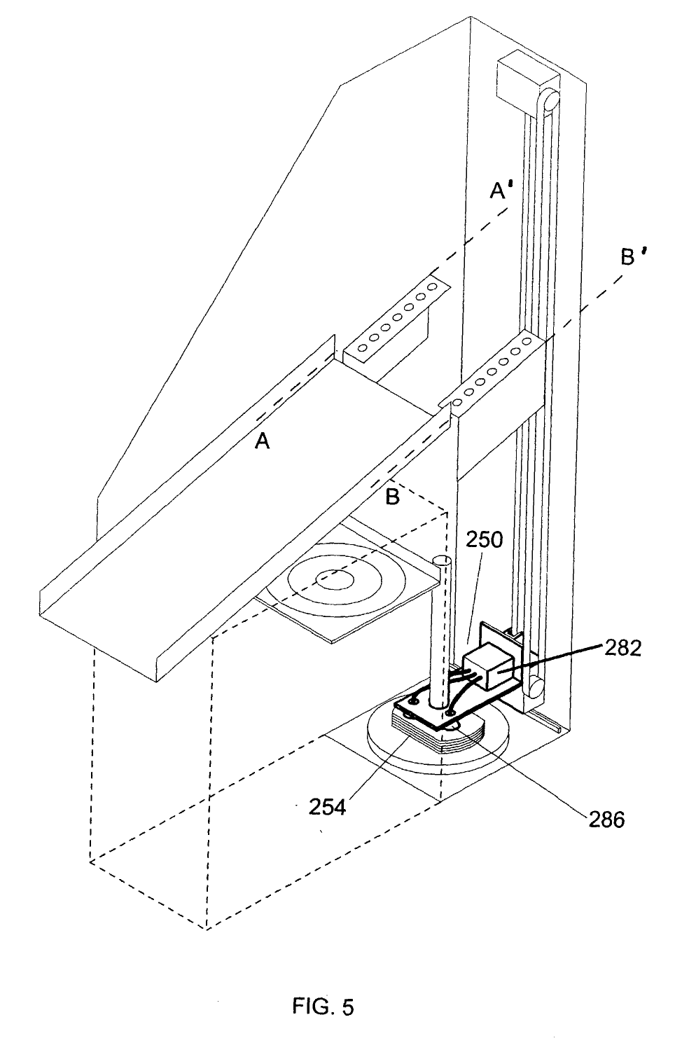

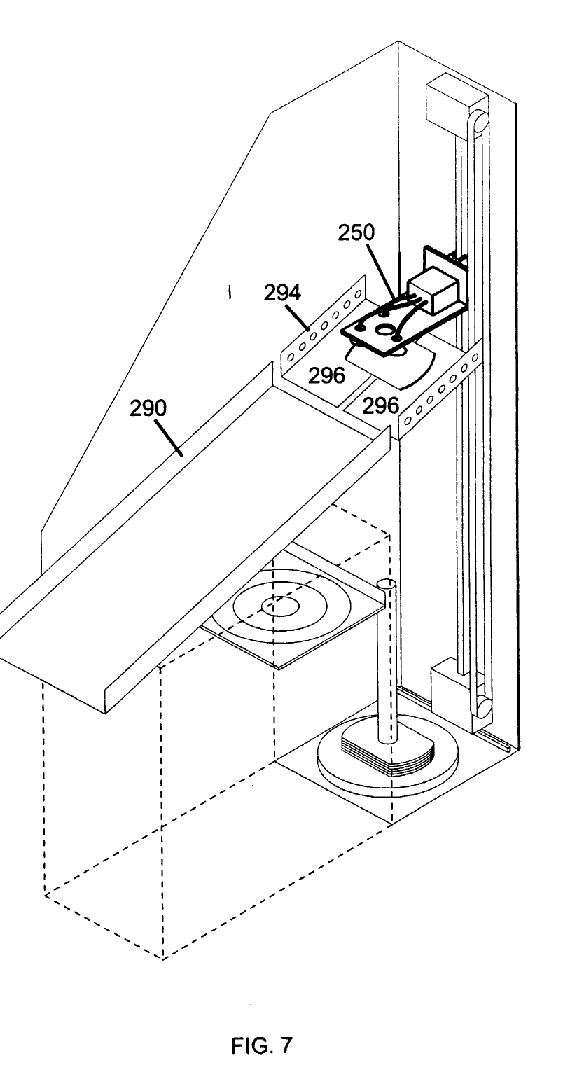

The disc dispensing mechanism comprises a gripper arm 250 that may move up and down track 252, and a stack of unrecorded CDs 254 located on circular post 256 this post being attached to a platter 258 fixed to the base of sub-enclosure 230. Rail 250 extends vertically along the back wall 260 of enclosure 230. The travel of gripper arm 250 along track 252 is limited by a lower track terminator 262 and an upper track terminator 264. Terminators 262 and 264 both house pulley wheels 266 and 268 respectively. An endless belt 270 connects pulley wheels 266 and 268. Belt 270 is preferably made of nylon and may have on its inner surface indentations to facilitate griping pulley wheels 266 and 268. Lower terminators 262 houses motor means (not shown) that drives lower pulley wheel 266 and hence pulley wheel 268 via belt 270. Belt 270 is attached to gripper arm 250. Hence, the gripper arm may be moved up and down track 252 by the motor means. This motor means may comprise a DC motor with a reduction gearbox. Gripper arm 250 comprises an end portion 280 that engages track 252, suction means 282 connected via suction lines 284 to suction pads 286. Suction means 282 may comprise a pump and solenoid; these may optionally be mounted on the outside of back wall 260 of sub-enclosure 230. Optionally, Suction pads 286 are located on the lower face of arm floor 288; said arm floor depending outwardly from end portion 280. Arm floor 288 has a circular aperture 278 so that it can move to the bottom end of track 252 without being impeded by post 256. However, the lower travel of the arm 250 will be restricted by the stack of unrecorded CDs 254. In the upper portion of sub-enclosure 230 there is an inclined chute 290; the lower portion 292 of which co-operates with dispensing slot 226. There is a retractable chute extension device 294 located beyond the upper end of chute 290. This chute extension comprises a pair of chute plates 296 that normally rest in a vertical plane; thereby allowing free travel upwardly and downwardly of gripper arm 250. However, during the disc dispensing mechanism cycle chute plates 296 pivot about a axes A-A′ and B-B′ (see FIG. 5) through an angle of about 90°, such that they form a chute floor (see FIG. 7) that extends upwardly beyond chute 290. This extension lies vertically below gripper arm 250 when this arm is in its uppermost position. The rear of back wall 260 has an electronics board PCB and processor (not shown) mounted on its outer face to control the motor means and means for actuating chute plates 296.

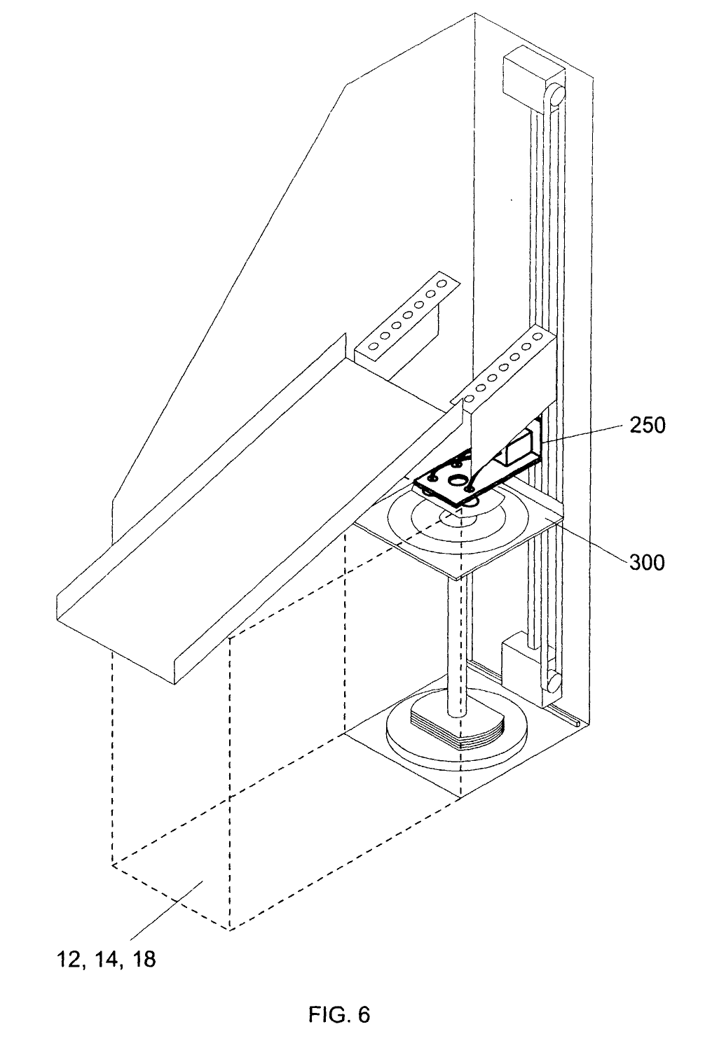

Operation of the disc dispensing mechanism will now be described by reference to FIGS. 4 to 7. At the start of the cycle the gripper arm 250 is located at the top end of its travel and the chute extension is open allowing free travel of arm 250 (see FIG. 4). Gripper arm 250 is then driven to the bottom end of its travel so that suction pads 286 abut the CD at the top of stack 254. Suction means 282 is then activated such that the top CD is held by suction to arm 250 (see FIG. 5). Gripper arm 250 then travels part way up the track 252 such that when tray 300 of CD writer 18 opens to accept a fresh CD; the CD held by arm 250 is located some distance above tray 300. Suction means 282 is then deactivated, and the CD drops into tray 300 prior to closure of the tray for recording on the CD (see FIG. 6). The gripper arm 250 then waits while the CD is written; when the CD writer tray 300 opens the gripper arm 250 picks up the CD by activating the suction means and also by moving downwards slightly; if required. Finally, gripper arm 250 moves to a position some distance higher that the chute extension 294; chute plates 296 rotate from vertical position to the position shown in FIG. 7 in order to form a floor. Suction means 282 is then deactivated; resulting in the recorded CD falling onto the floor of the chute extension and sliding down chute 290 to be dispensed to a user via dispensing slot 226. Arm 250 then travels to back to the top end of its travel (see FIG. 4) and the chute extension 296 opens; chute plates 296 returning to a vertical position.

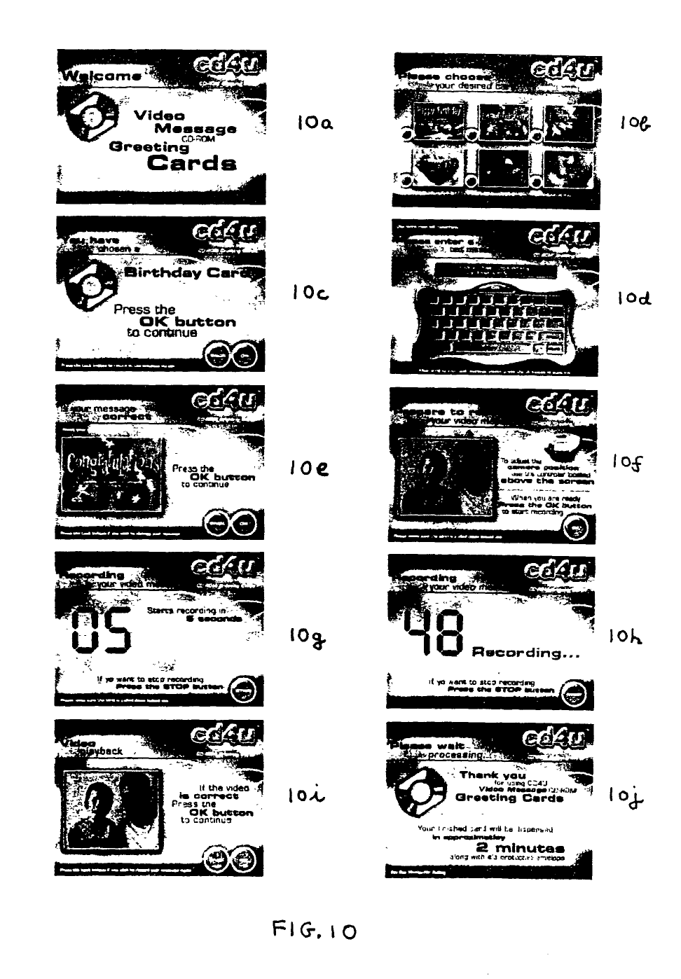

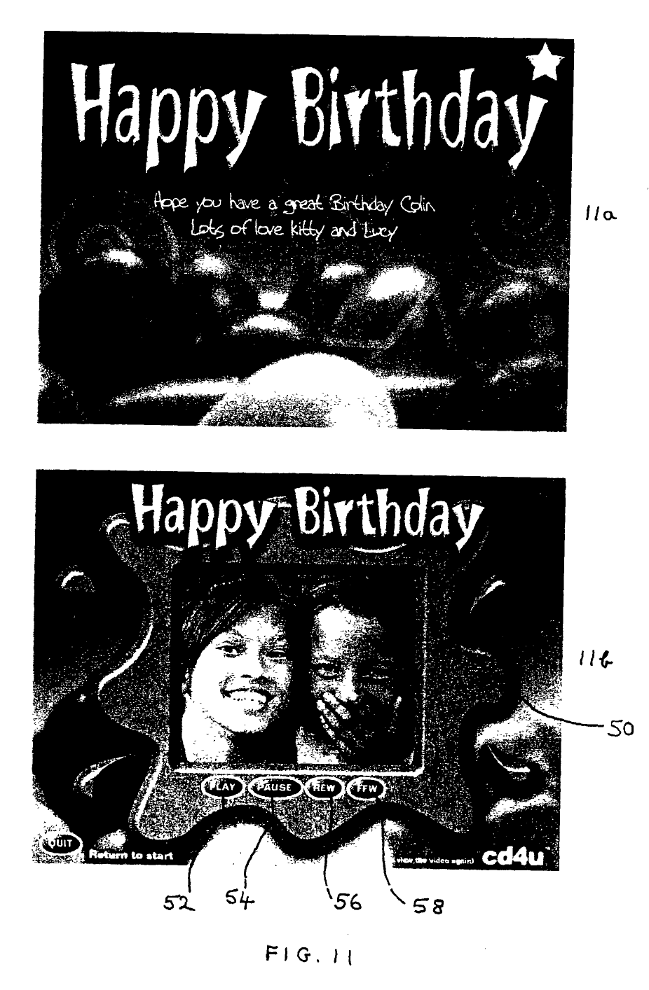

A user (U) of the apparatus desiring to record a video message positions himself/herself in the proximity of a camera 10 capable of recording moving images of the person. The apparatus may be used by a group of people rather than an individual in order to produce a video message from the group. The user will insert a token, coin, banknote, credit card or the like into the payment means 30 and the display 16 will then present a series of views according to FIGS. 10-a to 10-j. Thus, the user will first be asked to select a type of greeting card (FIG. 10-b) and then confirm this selection (FIG. 10-c). The user then has the option of entering a text message, using a touch screen facility on the display; for example “Hope you have a great birthday Colin, lots of love Kitty and Lucy” and is asked to confirm that the text message has been properly entered (FIG. 10-e). Next, a view is presented that gives the user options to adjust the camera 10, so that the camera records the desired view and/or adjust the position of a seat on which the user sits (not shown) relative to the camera or like means. During this stage the user is presented with the camera image presented in at least part of the view (FIG. 10-f). The user is next presented with a prompt that recording will start in say 5 seconds (FIG. 10-g) and an option to delay this if required. The apparatus then starts to film the user or users and during this period displays a countdown of the recording time remaining (FIG. 10-h) with an option to stop at any time and pass on to the next stage. Views 10-g and 10-h will not normally display the image being recorded, although this can be provided as an option. On completing the recording the user has an opportunity to review it in a playback facility (FIG. 10-i), if necessary several times, before proceeding to the final stage (FIG. 10-j) which initiates recording of the video from memory to a disc or the like by means of video recorder 18.

FIG. 11 shows two views of the video as seen during playback, for example by the recipient. The first view (11-a) has a greeting “Happy Birthday” with the text message “Hope you have a great birthday Colin, lots of love Kitty and Lucy” below. The video then moves on to show the recorded video sequence (see FIG. 11-b) within a frame 50 that also has a play 52, pause 54, rewind 56 and fast forward 58 button activated by a touch screen facility on the display.

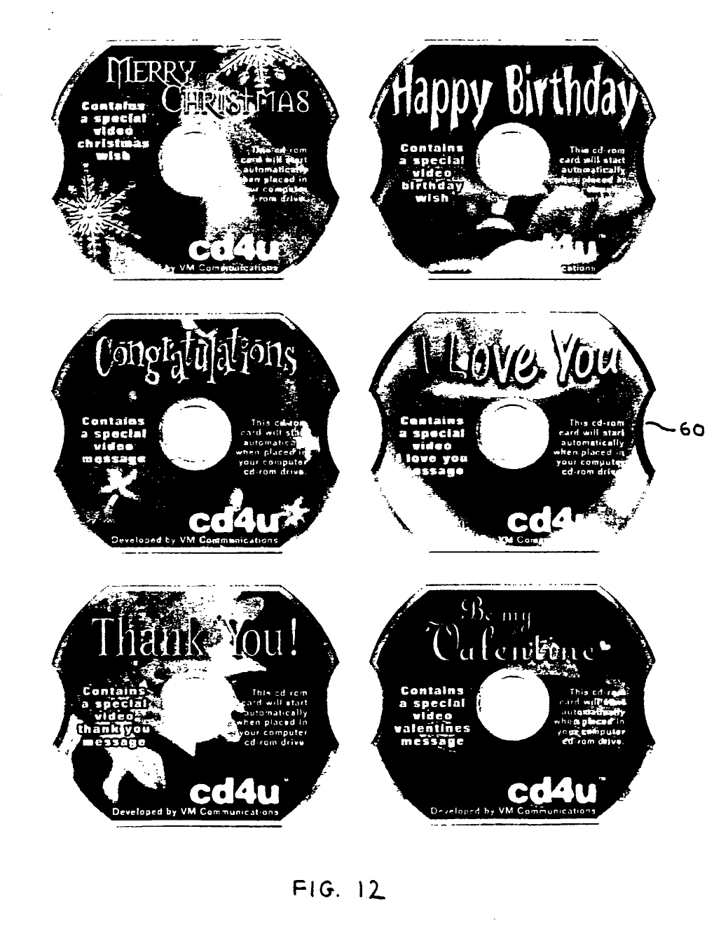

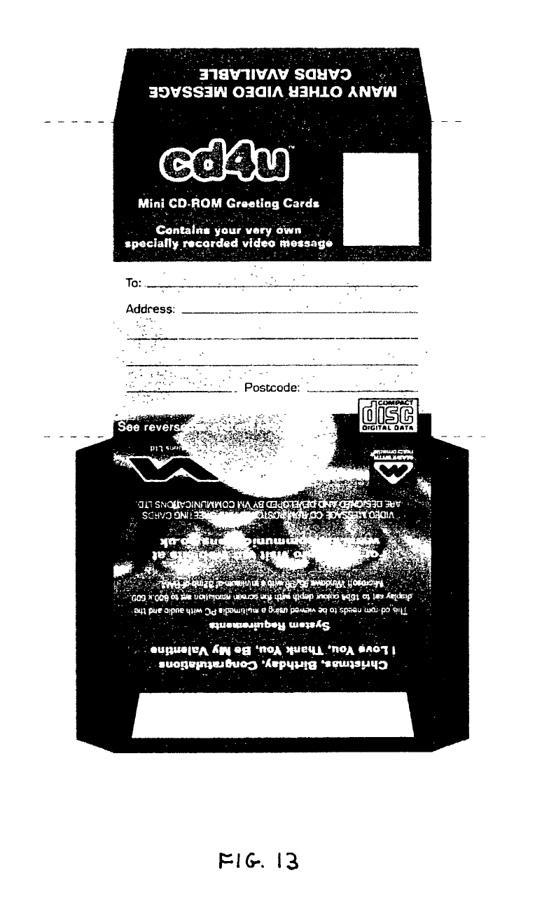

FIG. 12 shows examples of discs with various general greeting labels, for example “Congratulations”. The discs are preferably mini size, that is considerably smaller than standard size CDs, for example between 30 and 80 mm diameter. The CDs 60 may also have arcuate finger grip portions 62. If desired the discs can be considerably smaller than shown in FIG. 12; for example 30 to 40 mm diameter as only, a relatively small area of disc is required to record a video message of say 1 minute duration.

FIG. 13 shows an example of an envelope (E) that may be used to package a recorded disc. The disc is dispensed through vending aperture 22 with or within an unsealed envelope. This allows the user to inspect the disc, for example to check that it has the desired greeting label prior to sealing the envelope and sending it to a recipient. Optionally, the user may provide details of the recipient's address and the apparatus prints this address on the envelope/presentation package.

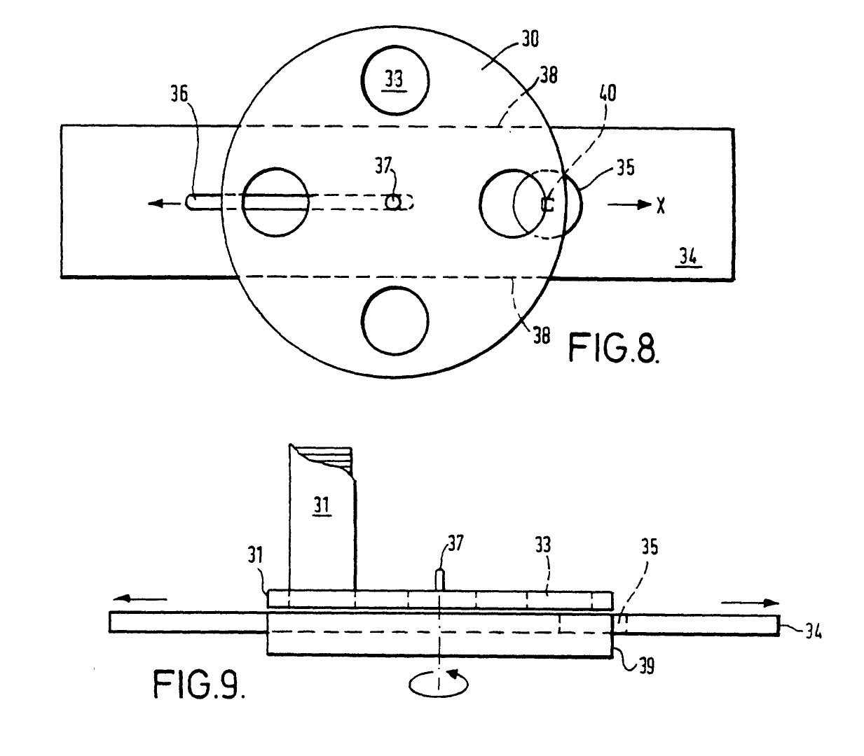

FIGS. 8 and 9 show an alternative disc mechanism suitable for use in the apparatus and method of the invention. Thus, a circular rotatable tray 30 has a plurality of apertures 33 each of slightly larger diameter than the disc and each having a feed tube 31 (only one shown) containing a stack of discs with the same label. Thus, in the dispensing mechanism shown four different label types could be dispensed. More or less label types may be dispensed by appropriate choice of the number of the apertures 33 and feed tubes 31. Under rotatable tray 30 there is located a generally rectangular shaped tray 34 with a circular recess 35 of similar size to apertures 33 adapted to hold a disc. An elongate slot 36 is provided in tray 34 and a restraining pin 37 is located at the centre of the rotatable tray 30, the purpose of which is to limit lateral movement of rectangular tray 34. This lateral movement is facilitated by a generally rectangular shaped channel 38 in a lower fixed tray 39. In use, the processor 12 causes motor means (not shown) to rotate tray 30 so that a disc with the desired type of label is dispensed into recess 35, rectangular tray 34 is then moved in direction X (see FIG. 8) so as to present the disc held within recess 35 to a suction arm device (not shown) that lifts the disc from the tray and drops it into, for example a CD writer. On completion of the recording step the same suction arm lifts the recorded disc from the video recorder and deposits it into the vending aperture 22.

In a further alternative, the disc dispensing mechanism 20 may comprise a generally annular shaped carrousel having a series of joined sleeves each capable of holding a disc with a rotatable plate beneath; the plate having at least one slots large enough to allow a disc to drop through it, wherein as the plate is rotated beneath a particular sleeve any disc therein may fall out of the sleeve through the slot and thereby be dispensed to a recorder.

The video recorder 18 may take the form of a CD or DVD writer. The user may enter text (see FIG. 11a) using a keyboard instead of a touch screen facility and the user may also select play control buttons 52, 54, 56 and 58 by a mouse instead of a touch screen facility. A label may be applied to a blank disc after recording the video message or even during recording the message. 18. Optionally, the user may select the presentation package and/or label on the video recording medium depending upon the preferred type of greeting.

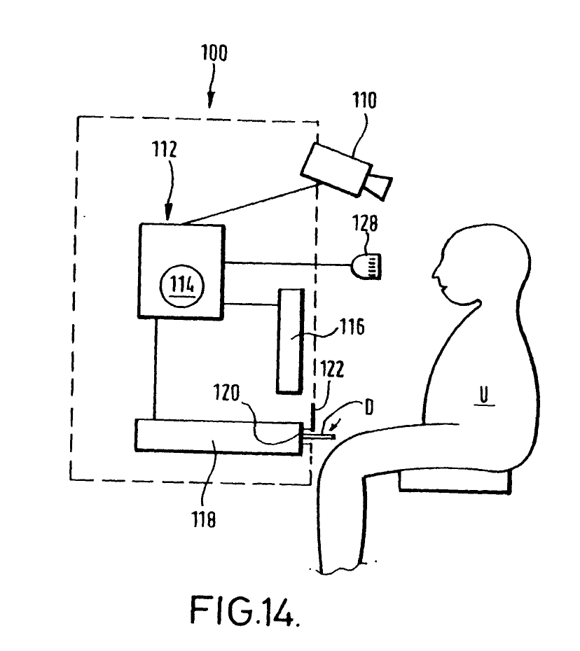

FIG. 14 shows, in diagramatic form only, the main components of the apparatus 100 according to a second embodiment of the invention. A video camera 110 records moving images of a user (U) and these are sent to a processor 112, for example a PC, with memory 114. Memory 114 will normally comprise both permanent “memory”, for example a hard disc and transient memory, for example RAM. The processor 112 is linked to a display unit 116 with a touch screen facility and to a video recorder 118 that can write to a compact disc. The user presents a pre-purchased blank disc (D) to the apparatus via a opening tray of slit aperture 120. On completion of the recording the disc is either returned via opening tray or slit aperture 120, or alternatively may be dispensed via a vending aperture (not shown). The authenticity of the blank disc may be established either by the apparatus reading a bar code or the like on the disc, or by the user entering a PIN number via the touch screen facility. Other forms of validating prepayment may be used including a magnetic strip reader that is swiped by the user before the disc is presented to the apparatus. In order to deter theft and damage by vandals the aperture 120 may be protected by closure means 122, such as a motorised vertically sliding security hatch or door. Thus, at an appropriate point during use, the closure means 122 opens to allow insertion of the blank disc (D) and then closes. Such means 122 would be in addition to any normal disc recorder tray mechanism or the like. The apparatus may also include a microphone 128 connected to processor 112 to allow both a visual and audio message to be recorded. Optionally, rather than being pre-purchased the blank disc may be provided as part of a promotional marketing campaign or the like; for example as a “gift” when a fast food type meal is purchased at a restaurant. In this event the means of validating the authenticity of the “gift” may be as described above in relation to validating pre-purchased disc.

Optionally, in the above described embodiments the user may request multiple copies of the recorded video each on a separate disc and normally vended in separate envelopes. This is valuable when the user desires to send a standard greeting; for example a Christmas greeting to a number of separate recipients. The user of the apparatus (U) may comprise a plurality of people and the user is not necessarily be seated; for example the individual(s) could be recorded while standing or moving within view of the camera. Optionally, the apparatus may housed in a booth located in a public place.

The invention offers the advantage that a recipient of a disc does not need to own a computer as the disc could be played in other equipment such as a television with a DVD player or the like. The recipient can keep the communication; for example, greeting in physical form like an ordinary card. In contrast, video communications sent as E-mail attachments are frequently deleted in order to conserve hard disc storage. The invention is particularly suited for installation within a booth, for example a booth located in a public place such as a retail outlet or in a shopping precinct. This offers the possibility of the facility being available on a 24 hour a day basis. Thus, the invention is likely to appeal to impulse purchasers, especially when other forms of greeting are found unsuitable. Users are also likely to be attracted by the speed and simplicity of the method and the ability to, for example immediately post it to the intended recipient.

Another advantage of the invention is the relatively simple disc dispenser 20 that in its preferred form uses a single arm traversing a track to accomplish both feeding of unrecorded discs to the video recording means and transfer of recorded discs from the recording means to a vending chute or aperture. In contrast, most known prior-art dispensers are complex and therefore both expensive to manufacture and maintain.

We claim:

1. Apparatus for producing a video communication comprising:
a video camera for viewing a user;
a display:
a processor with memory and software for presenting instructions on the display to a user;
video recording means;
means for presenting a selected unrecorded video recording medium to the video recording means;
means for presenting to the user on the video recording medium a recording of the communication; and
means for vending the recording to the user with a presentation package.

2. Apparatus according to claim 1 wherein means are provided to accept payment for use of the apparatus.

3. Apparatus according to claim 1 wherein the recording medium is a CD or recordable DVD disc.

4. Apparatus according to claim 1 wherein moving images recorded by the camera are stored in digital form in the memory and the user has the option of accepting or rejecting the images stored in memory prior to the images being recorded on the video recording medium.

5. Apparatus according to claim 1 wherein the user may instruct the processor to produce multiple copies of the recorded communication.

6. Apparatus according to claim 1 wherein the video communication takes the form of a greeting card or post card.

7. Apparatus according to claim 1 wherein means are provided for a user to include a written message with the video communication.

8. Apparatus according to claim 1 housed in a booth and intended for use within a public place.

9. Apparatus according to claim 1 wherein the means for presenting a video recording medium to a video recording means comprises a suction arm that lifts an unrecorded disc presented thereto and transfers it to the video recording means.

10. Apparatus according to claim 1 wherein the means for vending the recording to a user comprises a suction arm, that lifts the recorded disc from the video recording means and releases it into a vending aperture.

11. Apparatus for producing a video communication comprising:
a video camera for viewing a user;
a display; a processor with memory and software for presenting instructions on the display to the user;
video recording means that accepts data storage means presented by a user;
means of validating that means of authenticating storage means as authorised for use in said apparatus and;
means of dispensing to the user a recording of the video communication, on the data storage means.

12. Apparatus according claim 11 comprising an aperture with a security cover that operably moves from a closed to an open position to allow the data storage means to be presented to the apparatus.

13. Apparatus for producing a video communication comprising:
a video camera for viewing a user;
a display; a processor with memory and software for presenting instructions on the display to the user;
video recording means that accepts data storage means presented by a user;
means of validating that pre-payment has been received and;
means of dispensing to the user a recording of the video communication, on the data storage means.

14. Apparatus according to claim 13 wherein the means for validating pre-payment comprise entry of a PIN or code number by a key-pad, or means of reading a magnetic strip or bar code.

15. A method of producing a video communication comprising the steps of:
a user presenting data storage means to a video recorder;
validating that authenticating storage means as authorised for use in said apparatus;
recording a video communication and;
dispensing to the user a recording of the video communication, on the data storage means.

16. A method of producing a video communication comprising the steps of:
a user presenting data storage means to a video recorder;
validating that pre-payment has been received;
recording a video communication and;
dispensing to the user a recording of the video communication, on the data storage means.
